(19) United States
(12) Patent Application Publication
(10) Pub. No.: US 2018/0118555 A1
(43) Pub. Date: May 3, 2018

(54) Mobile Fryer Oil Vacuum Vessel

(71) Applicant: Dennis Smock, Sparks, NV (US)

(72) Inventor: Dennis Smock, Sparks, NV (US)

(21) Appl. No.: 15/860,387

(22) Filed: Jan. 2, 2018

Related U.S. Application Data
(62) Division of application No. 15/181,046, filed on Jun. 13, 2016.

(51) Int. Cl. B67D 7/02; A47J 37/12; B67D 7/84

(52) U.S. Cl. CPC B67D 7/0277; B67D 2210/00062; B67D 7/845; A47J 37/1285

(57) ABSTRACT

A system for removing oil from a deep fryer comprises a drum covered by a sealable drum lid, the drum lid having a top side and a bottom side, wherein the bottom side faces inside the drum. A hose having a first end connected to the drum lid and a second end having a nozzle. A vacuum unit is configured to generate suction through the second end of the hose towards the first end of the hose. The vacuum unit is mounted to the drum lid.

### RELATED APPLICATIONS

This non-provisional application claims the benefit of provisional application No. 67/174,961 filed on Jun. 15, 2015.

### BACKGROUND OF THE DISCLOSURE

### Technical Field of the Disclosure

The present embodiment relates generally to systems for removing the use of hot cooking oil from deep fryers, and more particularly, to a system and method of removing and recycling the used oil from a deep fryer.

### Description of the Related Art

Cooking oil does degrade after a period of time due to continuous exposure to the atmosphere and various food constituents under elevated temperature conditions and must be discarded. When this occurs the waste oil is typically drained from the fryer, usually at elevated temperatures, into a container that is carried by hand to a disposal tank at the rear of the facility housing the cooking installation. The high temperatures of the oil expose the worker to possible burn in contact with the heated oil. During removal of the hot oil from the kitchen area, spilling frequently occurs with flow behind the equipment itself.

Conventionally, a variety of frying machines are used in frying sausages, chicken, crisps or potato chips, etc. in the open air. In particular, deep fryer oil fires are not uncommon and can cause substantial damage to a restaurant, including destruction of the entire building the restaurant is in. Of course, and any fire situation there is substantial risk to individuals near the fire. It is found disadvantageous for the workers being burned by the hot oil during transport the hot cooking oil from the kitchen fryer. Ideally, it would be desirable for the automatic removal of the hot oil from the deep fryer that reduces the possibility that the fire may spread beyond the deep fryer, and greatly reduces possibility of injury to kitchen workers and emergency personnel.

Therefore, there is a need for a system for removing oil from a deep fryer. Such a needed system would provide a drum covered by a sealable drum lid. Such a needed system would provide a hose having a first end connected to the drum lid and a second end having a nozzle. Moreover, such a needed system would provide a vacuum unit configured to generate suction through the second end of the hose toward the first end of the hose. Such a needed device would further have multiple uses, such as reducing possibility of injury to kitchen workers and emergency personnel etc. The present embodiment overcomes the shortcomings and accomplishes these critical objectives.

### SUMMARY OF THE DISCLOSURE

To minimize the limitations found in the existing systems and methods, and to minimize other limitations that will be apparent upon the reading of the specifications, preferred embodiment of the present invention provides a system for removing oil from a deep fryer that comprises a drum covered by a sealable drum lid, the drum lid having a top side and a bottom side, wherein the bottom side faces inside the drum. A hose having a first end is connected to the drum lid and a second end is having a nozzle. A vacuum unit is configured to generate suction through the second end of the hose toward the first end of the hose. The vacuum unit is mounted to the drum lid. The hose is composed of material capable of withstanding a temperature of at least 400 degrees Fahrenheit. The nozzle includes an inlet pipe secured to the second end of the hose via a hose clamp. Further, the drum lid is configured to removably seal to the drum via lockable spill prevention ring coupled with a weather sealed motor.

The oil removing system further includes a 90 degree inlet elbow adapter. The elbow adapter having an elbow first end and an elbow second end, wherein the first end is bolted to the drum lid. A barb nipple connected to the elbow second end of the elbow adapter. The first end of the hose is disposed about the barb nipple and secured to the barb nipple by a heat resistant hose clamp. An oil drop off pipe connected to the elbow first end of the elbow adapter through an oil drop hole in the drum lid.

In this embodiment, the oil removing system further includes a prevention safety valve and the drum lid that has a motor inlet hole. The prevention safety valve connects to the vacuum unit through the motor inlet hole. The oil removing system, further including a mobility dolly that includes at least one caster hard rubber wheel having a diameter of approximately 3 inches connected to an under side of the drum.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

Elements in the figures have not necessarily been shown to scale in order to enhance their clarity and improve understanding of these various elements and embodiments of the invention. Furthermore, elements that are known to be common and well understood to those in the industry are not depicted in order to provide a clear view of the various embodiments of the invention, thus the figures are generalized in form in the interest of clarity and conciseness.

The foregoing summary as well as the following detailed description of the preferred embodiment of the present invention will be best understood when considered in conjunction with the accompanying figures, wherein like designations denote like elements throughout the figures, and wherein:

FIG. 1 illustrates a perspective view of an oil removing system in accordance with a preferred embodiment of the present invention;

FIG. 2 illustrates an exploded view of the oil removing system in accordance with a preferred embodiment of the present invention;

FIG. 3 illustrates a perspective front view of the oil removing system in accordance with a preferred embodiment of the present invention;

FIG. 4 illustrates a side perspective view of an elbow adapter bolted to the drum lid in accordance with a preferred embodiment of the present invention;

FIG. 5 illustrates an exploded view of the elbow adapter bolted to the drum lid in accordance with a preferred embodiment of the present invention; and

FIG. 6 illustrates a perspective front view of the oil removing system in use of transporting the drum to a biodiesel processor for beneficial reuse.

It is noted that the figures are intended to depict only typical embodiments of the invention and therefore should not be considered as limiting the scope thereof. It is further noted that the figures are not necessarily to scale. The invention will now be described in greater detail with reference to the accompanying figures.

### DETAILED DESCRIPTION OF THE PRESENT INVENTION

In the following discussion that addresses a number of embodiments and applications of the present invention, reference is made to the accompanying drawings that form a part hereof, and in which is shown by way of illustration specific embodiments in which the invention may be practiced. It is to be understood that other embodiments may be utilized and changes may be made without departing from the scope of the present invention.

Various inventive features are described below that can each be used independently of one another or in combination with other features. However, any single inventive feature may not address any of the problems discussed above or only address one of the problems discussed above. Further, one or more of the problems discussed above may not be fully addressed by any of the features described below.

As used herein, the singular forms “a”, “an” and “the” include plural referents unless the context clearly dictates otherwise. “And” as used herein is interchangeably used with “or” unless expressly stated otherwise. As used herein, the term “about” means+/−5% of the recited parameter. All embodiments of any aspect of the invention can be used in combination, unless the context clearly dictates otherwise.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of “including, but not limited to”. Words using the singular or plural number also include the plural and singular number, respectively. Additionally, the words “herein,” “wherein”, “whereas”, “above,” and “below” and words of similar import, when used in this application, shall refer to this application as a whole and not to any particular portions of the application.

The description of embodiments of the disclosure is not intended to be exhaustive or to limit the disclosure to the precise form disclosed. While the specific embodiments of, and examples for, the disclosure are described herein for illustrative purposes, various equivalent modifications are possible within the scope of the disclosure, as those skilled in the relevant art will recognize.

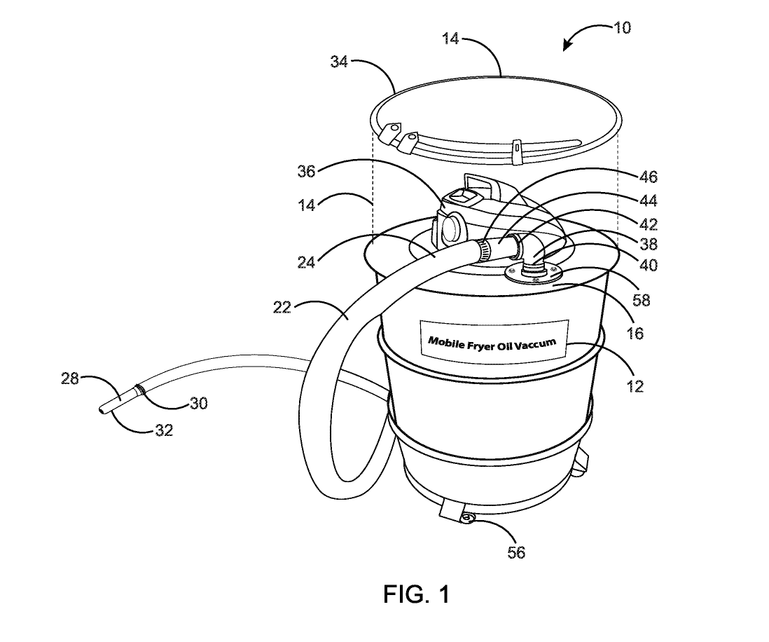

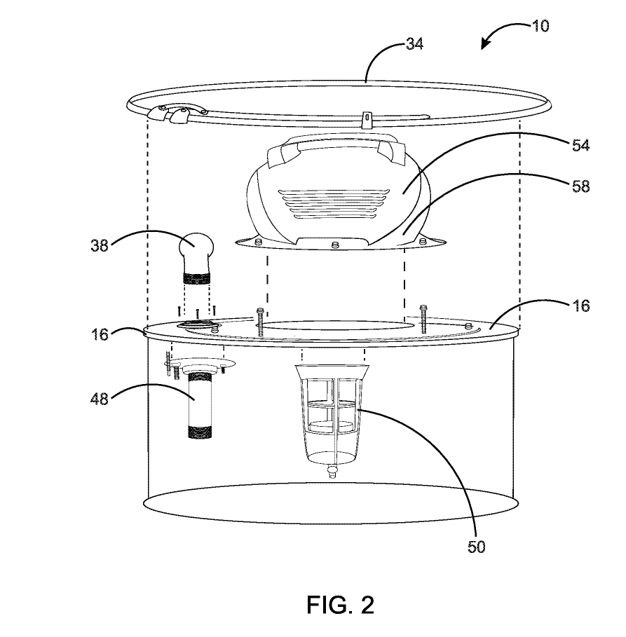

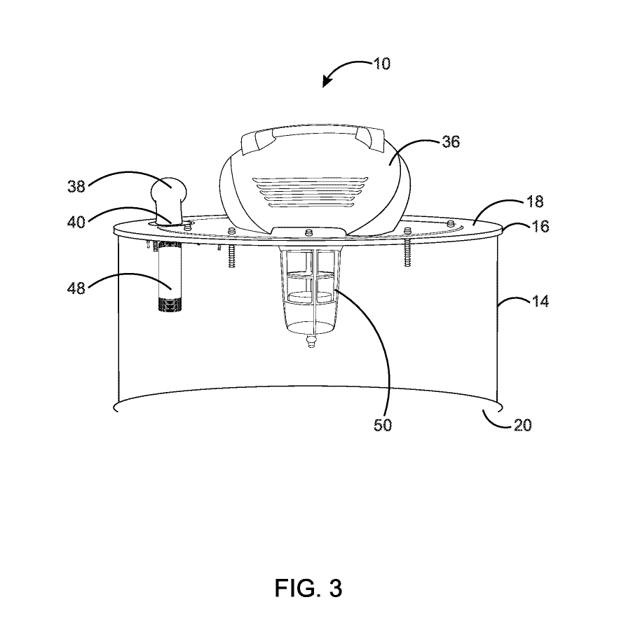

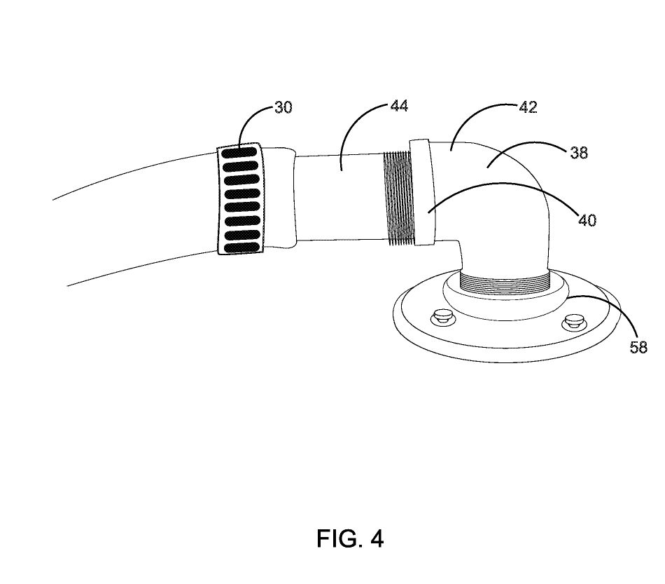

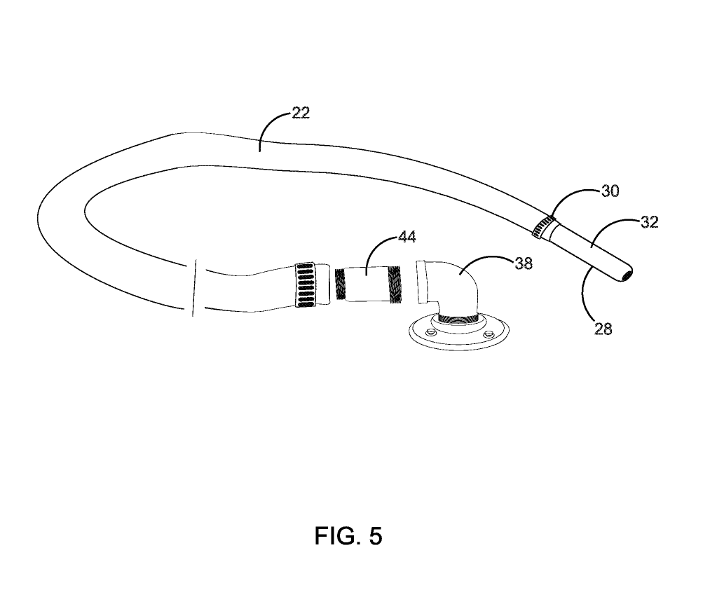

Turning to FIGS. 1-6, an oil removing system 10 as shown for removing oil from a deep fryer 12 is illustrated, here a drum 14 covered by a sealable drum lid 16, the drum lid 16 having a top side 18 and a bottom side 20, wherein the bottom side 20 faces inside the drum 14. A hose 22 having a first end 24 is connected to the drum lid 16 and a second end 26 having a nozzle 28. A vacuum unit 54 is configured to generate suction through the second end 26 of the hose 22 toward the first end 24 of the hose. The vacuum unit 54 is mounted to the drum lid 16. The hose 22 is composed of material capable of withstanding a temperature of at least 400 degrees Fahrenheit. The nozzle 28 includes an inlet pipe 32 secured to the second end 26 of the hose 22 via a hose clamp 30. The drum lid 16 is configured to removably seal to the drum 14 via lockable spill prevention ring coupled with a weather sealed motor 36.

The oil removing system 10 further includes a 90 degree inlet elbow adapter 38. The elbow adapter 38 is having an elbow first end 40 and an elbow second end 42, wherein the elbow first end 40 is bolted to the drum lid 16. A barb nipple 44 is connected to the elbow second end 42 of the elbow adapter 38. The first end 24 of the hose 22 is disposed about the barb nipple 44 and secured to the barb nipple 44 by a heat resistant hose clamp 46. An oil drop off pipe 48 is connected to the elbow first end 40 of the elbow adapter 38 through an oil drop hole in the drum lid 16.

In this embodiment, the oil removing system 10 further includes a prevention safety valve 50 and the drum lid 16 has a motor inlet hole 52. The prevention safety valve 50 connects to the vacuum unit 54 through the motor inlet hole 52. The oil removing system 10, further including a mobility dolly (not shown) that includes at least one caster hard rubber wheel 56 having a diameter of approximately 3 inches connected to an under side of the drum.

A method for removing and recycling the used oil from a deep fryer 12 in accordance with the preferred embodiment of the present invention is provided. The method is initiated by providing an oil removing system 10 having a drum 14, a hose 22 and a vacuum unit 54. The hose 22 is placed into an oil vessel of the deep fryer. Thereafter, activating the vacuum unit 54 to suction the used oil through a nozzle 28, then through the hose 22 and then into the drum 14 until the drum 14 becomes full. Then, the lid is removed from the drum 14 for transporting the full drum 14 to a biodiesel processor for beneficial reuse.

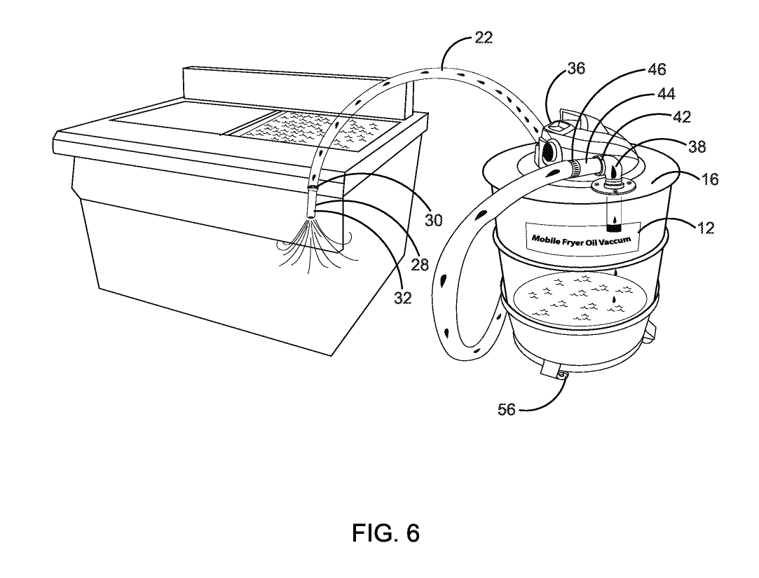

In accordance with a preferred embodiment, the motor 36 and pump mounts in the removable drum lid 16 of the vacuum unit 54 and powered by 110 volt power outlet and creates 110 CFM free air flow. The approximate dimensions of the high temperature vacuum hose is 1½ inches in diameter and six feet in length with a 12 inch metallic wand. In use, a 55 gallon vessel or drum is used to create a vacuum inside and is used to contain & confine the used and spent fryer oil that is vacuumed from the kitchen deep fryer. This component is crucial for containing the hot fryer oil to lessen or eliminate the chance of workers being burned by the hot oil and contains fryer oil for transport away from the kitchen deep fryer. In process the vacuum hose 22 mount onto the top of the removable drum lid 16 and are located on the top of the drum 14. The metallic wand is submerged into the used fryer oil and the drum pulls the used oil from the deep fryer and into the drum 14. When the drum 14 is filled with used fryer oil, the removable drum lid 16 is removed along with the high temperature hose to facilitate the removal of the fryer oil from the drum by means of a transport vacuum truck to be transported to a biodiesel processor (See FIG. 6) for the beneficial reuse. The hose 22 can withstand temperature in excess of 400 degrees and also mounts into the vacuum unit 54 enclosed with a lock down removable drum lid. The fryer oil vacuum vessel is unique in that it enables the restaurant manager or worker to never have to touch the fryer oil once it is placed in the deep fryer and heated up to 350 degrees.

In this embodiment, the approximate dimensions of the cylindrical design drum 14 have a diameter of 23.5 inches, 33 inches high, and the dimension of at least one caster hard rubber wheel 56 having a diameter of approximately 3 inches diameter and are enclosed with a lock down removable lid. The lock down removable lid 34 is made of 16 gauge steel and has a liquid volume of 50 gallons.

The foregoing description of the preferred embodiment of the present invention has been presented for the purpose of illustration and description. It is not intended to be exhaustive or to limit the invention to the precise form disclosed. Many modifications and variations are possible in the system of the above teachings. It is intended that the scope of the present invention not be limited by this detailed description, but by the claims and the equivalents to the claims appended hereto.

What is claimed is:

1. A system for removing oil from a deep fryer comprising:
a. a drum covered by a sealable drum lid, the drum lid having a top side and a bottom side, wherein the bottom side faces inside the drum;
b. a hose having a first end connected to the drum lid and a second end having a nozzle;
c. a vacuum unit configured to generate suction through the hose from the second end of the hose toward the first end of the hose.

2. The system of claim 1 wherein the vacuum unit is mounted to the drum lid.

3. The system of claim 1 wherein the hose is composed of material capable of withstanding a temperature of at least 400 degrees Fahrenheit.

4. The system of claim wherein the nozzle comprises an inlet pipe secured to the second end of the hose via a hose clamp.

5. The system of claim 1 wherein the drum lid is configured to removably seal to the drum via lockable spill prevention ring coupled with a weather seal.

6. The system of claim 1 further including:
a. a 90 degree inlet elbow adapter, the elbow adapter having a first end and a second end, wherein the first end is bolted to the drum lid;
b. a barb nipple connected to the second end of the elbow adapter;
c. wherein the first end of the hose is disposed about the barb nipple and secured to the barb nipple by a heat resistant hose clamp;

7. The system of claim 6, further including an oil drop off pipe connected to the first end of the elbow adapter through an oil drop hole in the drum lid.

8. The system of claim 1:
a. further including a prevention safety valve;
b. wherein the drum lid has a motor inlet hole;
c. wherein the prevention safety valve connects to the vacuum unit through the motor inlet hole.

9. The system of claim 1, further including a mobility dolly connected to an under side of the drum.
